(19) United States
(12) Patent Application Publication
(10) Pub. No.: US 2025/0181930 A1
(43) Pub. Date: Jun. 5, 2025

(54) System and method to validate exceptions associated with data interactions using a tangle network

(71) Applicant: Bank of America Corporation, Charlotte, NC (US)

(72) Inventors: Raja Arumugam Maharaja, Chennai (IN); Sonali Pal, New Delhi (IN); Priya Manchanda, New Delhi (IN); Hitendra Kumar, Ghaziabad (IN); Subramanian Srinivasan, Chennai (IN); Sharat Chandran, Hyderabad (IN); Anurag Singh, Gurgaon (IN)

(21) Appl. No.: 18/526,410

(22) Filed: Dec. 1, 2023

(51) Int. Cl. G06N 3/098

(52) U.S. Cl. CPC G06N 3/098

(57) ABSTRACT

A plurality of data interactions are monitored and a plurality of potential exceptions relating to the data interactions are identified. Each potential exceptions is analyzed based on a respective pre-configured logic to determine a result relating to the potential exception. A plurality of data objects are generated, wherein each data object includes one or more of the potential exceptions, the results determined for the potential exceptions and other related data. The data objects are passed as nodes of a tangle associated with a tangle network. A federated machine learning (ML) model is deployed with each node passed to the tangle to determine whether the results are correct. A report is generated including a plurality of potential exceptions determined as valid.

### TECHNICAL FIELD

The present disclosure relates generally to computing networks, and more specifically to a system and method for validating exceptions associated with data interactions performed in a computing infrastructure using a tangle network.

### BACKGROUND

Certain data interactions performed within a computing infrastructure need to be reported to one or more entities. Often exceptions occur during reporting of data interactions, wherein an exception associated with reporting a particular data interaction indicates an error in reporting the data interaction to the respective entity. Example exceptions associated with reporting data interactions may include, but are not limited to, missing fields during reporting, duplicate data being reported, and erroneous/incorrect data being reported. The exceptions in reporting data interactions may occur because of technical and/or logical errors in generating and/or processing the reports. In traditional systems, a pre-configured logic is used to determine whether one or more exceptions have occurred in reporting data interactions. However, the pre-configured logic and the data used by the pre-configured logic to make the determinations of the exceptions may not always correctly identify exceptions. Improper identification of the exceptions may lead to reporting errors not being resolved in a timely manner leading to missed reporting deadlines causing several issues including fines, loss of trust, loss of reputation and legal issues.

### SUMMARY

The system and method implemented by the system as disclosed in the present disclosure provide technical solutions to the technical problems discussed above by accurately determining exceptions associated with reporting data interactions.

For example, the disclosed system and methods provide the practical application of confirming determinations of exceptions associated with reporting data interactions. In other words, the techniques described in accordance with embodiments of this disclosure confirm the correctness of a determination that an exception has occurred or not occurred in relation to reporting a data interaction. As described in more detail below, to confirm the results (e.g., exception occurred or not occurred) determined for the potential exceptions identified with respective to reporting certain data interactions, an exception manager leverages a tangle network that implements a tangle. Exception manager segregates the results determined for the potential exceptions and the related data recorded by the exception manger into at least three parts and stores each part in a separate data object, namely, a first data object, a second data object and a third data object. Exception manager iteratively (e.g., one by one) passes to the tangle network, each of the first data object, second data object and third data object as new tangle nodes of the tangle. Exception manager further deploys a federated machine learning (ML) model with each tangle node passed to the tangle network. The federated ML models iteratively determine based on the newly added tangle nodes whether the results determined for the potential exceptions are correct.

By leveraging the tangle network to determine the correctness of the results associated with potential exceptions, the exception manager allows the determinations made by the federated ML models to be based only on the latest data from the previous two tangle nodes and no old historical data that may not be relevant anymore. This improves the accuracy associated with identifying exceptions that occurred in relation to reporting data interactions. This increased accuracy in identifying exceptions avoids computing resources (e.g., processing and memory resources) from being unnecessary deployed to resolve exceptions that were incorrectly identified. The saving of computing resources improves efficiency of computing nodes processing the reporting of the data interactions.

Additionally, by iteratively employing machine learning models by providing additional relevant data at each iteration, the disclosed system and method improves the accuracy of the machine learning models used to verify exceptions associated with data interactions.

Further, by improving detection of exceptions associated with reporting of data interactions, the disclosed system and method help ensure that data is accurately reported to requisite entities. This improves data integrity and data accuracy in the computing network.

Thus, the disclosed system and method generally improves technology associated with processing data interactions in a computing network.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for detecting exceptions associated with reporting data interactions, in accordance with one or more embodiments of the present disclosure.

### DETAILED DESCRIPTION

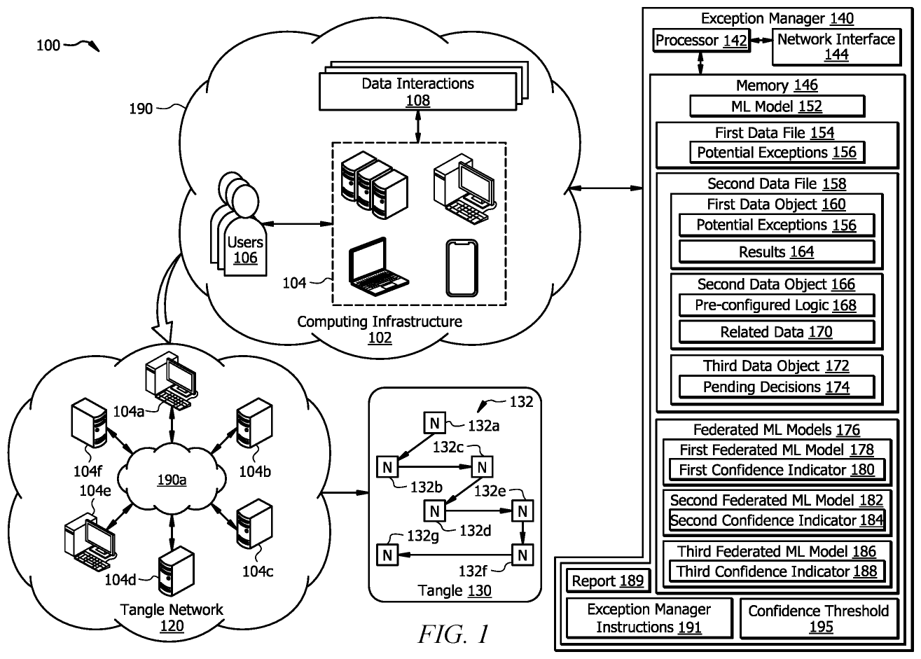

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software and other customized software programs implementing particular functionalities. For example, software code relating to one or more software applications may be stored in a memory device and one or more processors (e.g., belonging to one or more computing nodes 104) may execute the software code to implement respective functionalities (e.g., exception manager 140). In one embodiment, at least a portion of the computing infrastructure 102 may be representative of an Information Technology (IT) infrastructure of an organization.

One or more of the computing nodes 104 may be operated by a user 106. For example, a computing node 104 may provide a user interface using which a user 106 may operate the computing node 104 to perform data interactions within the computing infrastructure 102.

One or more computing nodes 104 of the computing infrastructure 102 may be representative of a computing system which hosts software applications that may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality (e.g., exception manager 140) as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

At least a portion of the computing infrastructure 102 may include a tangle network 120. For example, a portion of the computing nodes 104 may form the tangle network 120. As shown in FIG. 1, an example tangle network 120 includes computing nodes 104a, 104b, 104c, 104d, 104e and 104f connected to each other via a portion of the network 190 (shown as 190a). The tangle network 120 implements distributed computing which generally refers to a method of making multiple computers (e.g., computing nodes 104a-104f) work together to solve a common problem. This makes a computer network (e.g., tangle network 120) appear as a powerful single computer that provides large-scale resources to deal with complex challenges. For example, distributed computing can encrypt large volumes of data, solve complex physics and chemical equations with many variables, and render high-quality, three-dimensional video animation. Distributed computing often uses specialized software applications that are configured to run on several computing nodes 104 instead of on just one computer, such that different computers perform different tasks and communicate to develop the final solution. High-performing distributed computing is often used in engineering research, financial services, energy sector and the like to run complex processes.

The tangle network 120 implements a tangle 130 which includes a plurality of tangle nodes 132 (shown as 132a-132g) in a Directed Acyclic Graph (DAG) configuration. Each tangle node 132 is a data object that represents a single data interaction conducted in the tangle network 120, wherein tangle nodes 132 are connected to each other using edges/arcs. The DAG configuration of the tangle 130 means that the tangle nodes 132 of the tangle 130 follow a single direction and do not loop back, as shown by the directional arrows connecting the tangle nodes 132. In some embodiments, each tangle node 132 of the tangle 130 points to at least two and up to eight previously generated tangle nodes 132. Once a particular tangle node 132 is connected to (e.g., pointed at by) two newly generated tangle nodes 132, the particular tangle node 132 and the data interaction represented by the particular tangle node 132 is considered confirmed. Once a tangle node 132 is generated and confirmed, it is generally immutable, thus providing high data security to the tangle network 120. In some cases, the plurality of tangle nodes 132 implemented by the tangle network 120 is interchangeably referred to as the tangle 130 or DAG. The tangle 130 or a portion thereof is stored in a distributed fashion by a plurality of computing nodes 104 of the tangle network 120. It may be noted that, unlike a blockchain network where each computing node connected to the blockchain network stores an entire copy of the blockchain, a computing node 104 of the tangle network 120 may store only a portion of the tangle 130. This characteristic of the tangle network 120 saves memory at the computing nodes 104 of the tangle network 120 and improves overall performance of the tangle network 120. In certain embodiments, each new tangle node 132 that is added to the tangle 130 has access to data stored in two other tangle nodes 132 previously added to the tangle 130. For example, assuming that tangle node 132a is the newest tangle node and tangle node 132f is the oldest tangle node, tangle node 132a has access to data stored in tangle nodes 132b and 132c, tangle node 132b has access to data stored in tangle nodes 132c and 132d, tangle node 132c has access to data stored in tangle nodes 132d and 132e, and so on.

In some cases, certain data interactions 108 performed within the computing infrastructure 102 need to be reported to one or more entities. For example, in a banking environment, information relating to certain trading transactions may need to be reported to certain regulatory entities. Often exceptions occur during reporting of data interactions 108, wherein an exception associated with reporting a particular data interaction 108 indicates a possible error in reporting the data interaction to the respective entity. Example exceptions associated with reporting data interactions 108 may include, but are not limited to, missing fields during reporting, duplicate data being reported, and erroneous/incorrect data being reported. The exceptions in reporting data interactions 108 may occur because of technical and/or logical errors in generating and/or processing the reports. In traditional systems, a pre-configured logic is used to determine whether one or more exceptions have occurred in reporting data interactions. However, the pre-configured logic and the data used by the pre-configured logic to make the determinations of the exceptions may not always correctly identify exceptions. For example, a pre-configured logic may identify an exception that has not actually occurred or identify that an exception has not occurred when it has actually occurred. Exceptions associated with reporting of data interactions need to be resolved and corrected in a timely manner. However, improper identification of the exceptions may lead to reporting errors not being resolved in a timely manner leading to missed reporting deadlines causing several issues including fines, loss of trust, loss of reputation and legal issues.

Improper identification of exceptions may occur because of several reasons. In one example, the pre-configured logic used to determine exceptions may be old and may not be configured to consider relatively newer data points/variables and/or dynamically changing values associated with certain variables to make the determinations. In another example, the pre-configured logic may rely on historical data that may not be relevant anymore. For example, a traditional system may be configured to report a data interaction when a number of data objects transferred between two entities as part of the data interaction equals or exceeds a threshold. However, an actual amount of the data objects transferred between the entities may be different from the number of data objects initially scheduled for the transfer based on a value associated with each data object, wherein the value of the data object may fluctuate dynamically. Thus, the actual number of data objects that are transferred may be different from the number of data objects originally scheduled to be transferred. The pre-configured logic that determines whether an exception has occurred with regard to reporting the data interaction may be configured to determine whether the data interaction is to be reported based on the number of data objects scheduled to be transferred. This means that the pre-configured logic determines that the data interaction is to be reported when the scheduled number of data objects equals or exceeds the threshold and determines that the data interaction is not to be reported when the scheduled number of data objects is lower than the threshold. Thus, in some cases, when the scheduled number of data objects is below the threshold but the number of data objects actually transferred is higher than the threshold as a result of the data objects increasing in value after the scheduling, the pre-configured logic may erroneously determine that the data interaction is not to be reported. However, in this case, the data interaction is to be reported since the actual number exceeded the threshold. But, when the data interaction is actually not reported, the pre-configured logic erroneously determines that an exception has not occurred resulting in the actual exception not being resolved and the related reporting not being corrected. On the other hand, when the scheduled number exceeds the threshold while the actual number is below the threshold as a result of the data objects dropping in value after scheduling, the pre-configured logic may erroneously determine that the data interaction is to be reported. However, in this case, the data interaction is not to be reported since the actual number is lower than the threshold. But, when the data interaction is rightly not reported, the pre-configured erroneously determines that an exception has occurred and time and resources are wasted to detect and resolve the root cause of this erroneous exception.

Embodiments of the present disclosure describe techniques for confirming determinations of exceptions associated with reporting data interactions. In other words, the techniques described in accordance with embodiments of this disclosure confirm the correctness of a determination that an exception has occurred or not occurred in relation to reporting a data interaction.

At least a portion of the computing infrastructure 102 (e.g., one or more computing nodes 104) may implement an exception manager 140 which may perform a plurality of operations associated with identifying, validating/confirming, resolving and reporting exceptions associated with data interactions 108 performed in the computing infrastructure 102. The exception manager 140 comprises a processor 142, a memory 146, and a network interface 144. The exception manager 140 may be configured as shown in FIG. 1 or in any other suitable configuration.

The processor 142 comprises one or more processors operably coupled to the memory 146. The processor 142 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 142 may be a programmable logic device, a microcontroller, a microprocessor, or any suitable combination of the preceding. The processor 142 is communicatively coupled to and in signal communication with the memory 146. The one or more processors are configured to process data and may be implemented in hardware or software. For example, the processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

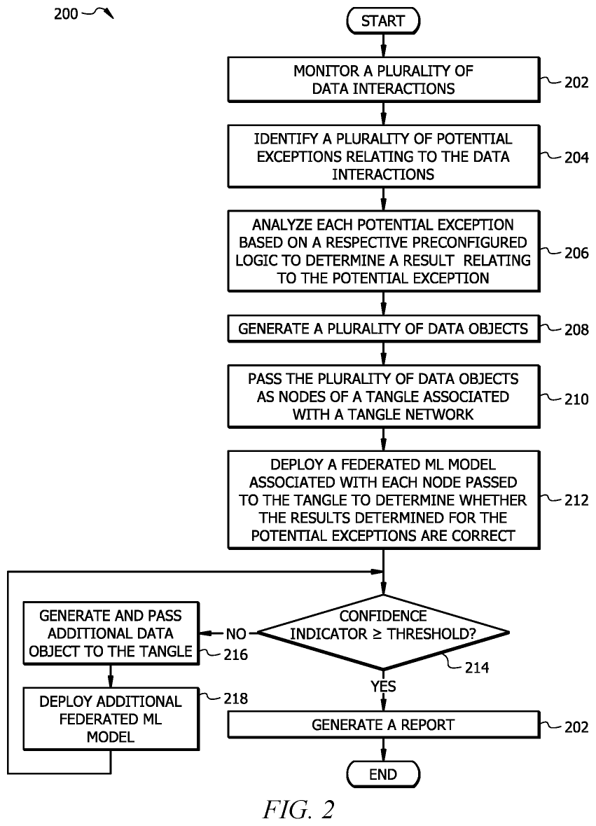

The one or more processors are configured to implement various instructions, such as software instructions. For example, the one or more processors are configured to execute instructions (e.g., exception manager instructions 191) to implement the exception manager 140. In this way, processor 142 may be a special-purpose computer designed to implement the functions disclosed herein. In one or more embodiments, the exception manager 140 is implemented using logic units, FPGAs, ASICs, DSPs, or any other suitable hardware. The exception manager 140 is configured to operate as described with reference to FIG. 2. For example, the processor 142 may be configured to perform at least a portion of the method 200 as described in FIG. 2.

The memory 146 comprises a non-transitory computer-readable medium such as one or more disks, tape drives, or solid-state drives, and may be used as an over-flow data storage device, to store programs when such programs are selected for execution, and to store instructions and data that are read during program execution. The memory 146 may be volatile or non-volatile and may comprise a read-only memory (ROM), random-access memory (RAM), ternary content-addressable memory (TCAM), dynamic random-access memory (DRAM), and static random-access memory (SRAM).

The memory 146 is operable to store machine learning (ML) model 152, first data file 145, second data file 158, federated machine learning (ML) models 176, report 189 and the exception manager instructions 191. The exception manager instructions 191 may include any suitable set of instructions, logic, rules, or code operable to execute the exception manager 140.

The network interface 144 is configured to enable wired and/or wireless communications. The network interface 144 is configured to communicate data between the exception manager 140 and other devices, systems, or domains (e.g., computing nodes 104). For example, the network interface 144 may comprise a Wi-Fi interface, a LAN interface, a WAN interface, a modem, a switch, or a router. The processor 142 is configured to send and receive data using the network interface 144. The network interface 144 may be configured to use any suitable type of communication protocol as would be appreciated by one of ordinary skill in the art.

It may be noted that each of the computing nodes 104 may be implemented like the exception manager 140 shown in FIG. 1. For example, each of the computing nodes 104 may have a respective processor and a memory that stores data and instructions to implement operations performed by the computing node 104.

Exception manager 140 may be configured to monitor a plurality of data interactions 108 performed in the computing infrastructure 102. For example, a data interaction 108 performed in the computing infrastructure may include transfer of data objects between two computing nodes 104 of the computing infrastructure. Based on monitoring the plurality of data interactions 108, exception manager 140 may be configured to determine one or more potential exceptions 156 in relation to each of the monitored data interactions 108. A potential exception 156 associated with a particular data interaction 108 may include a reporting error that is known to occur and/or can occur in relation to reporting the particular data interaction 108, for example, to a designated entity. Exception manager 140 may be configured to determine a list of all potential exceptions 156 related to each monitored data interaction 108. In one embodiment, exception manager 140 generates a first data file 154 and stores the list of potential exceptions 156 determined for the monitored data interactions 108 in the first data file 154. At this stage, each determined potential exception 156 indicates a possible error that may occur in relation to the respective data interaction 108. In other words, none of the potential exceptions 156 indicate an actual exception/error that has occurred in relation to reporting a respective data interaction 108. In an additional embodiment, exception manager 140 records one or more data points that are known to influence one or more of the potential exceptions 156. For example, a processing delay at a computing node 104 that processes reporting of a particular data interaction 108 may cause the reporting to be delayed beyond a reporting deadline. In this case, the exception manager 140 may record one or more parameters that indicate performance of the computing node 104. Exception manager 140 may store the recorded data points in the first data file 154.

Exception manager 140 may be configured to analyze each potential exception 156 from the first data file 154 and determine a result 164 in relation to the potential exception 156, wherein the result 164 indicates whether the potential exception 156 is a valid exception meaning that the potential exception 156 actually occurred during reporting of the particular data interaction 108. For example, for a potential exception 156 listed in the first data file 154, a result determined by the exception manager 140 includes whether the potential exception is valid (actually occurred) or invalid (did not occur). To determine a result 164 in relation to a potential exception 156 determined for a particular data interaction 108, the exception manager 140 applies a pre-configured logic 168 that is configured to determine whether the potential exception 156 is a valid exception, meaning whether the potential exception 156 actually occurred during reporting of the particular data interaction 108. The pre-configured logic 168 may be configured to use one or more data points to determine whether a potential exception 156 actually occurred in relation to reporting a particular data interaction 108. Following the example described above, when a particular data interaction 108 is to be reported when the number of data objects transferred between computing nodes 104 as part of the particular data interaction 108 equals or exceeds a threshold, the pre-configured logic 168 may be configured to use the number of data objects scheduled to be transferred to determine whether an exception has occurred in relation to reporting the particular data interaction 108.

In additional or alternative embodiments, the exception manager 140 may be configured to record related data 170 that may be relevant to determining whether a particular potential exception 156 is a valid exception. Related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156. For example, other data points that may be relevant to the particular potential exception 156 may include performance parameters associated with a computing node 104 that is configured to process the reporting of the particular potential exception 156. As described above, in one example, a delay in processing reporting of a particular exception 156 may cause delayed reporting of a respective data interaction 108 associated with the exception 156 or to cause the data interaction to be not reported at all.

Exception manager 140 may be configured to confirm a result 164 determined for a potential exception 156. In other words, the exception manager 140 may be configured to determine whether a result 164 determined for a potential exception 156 is correct or incorrect. For example, when a result 164 determined for a particular potential exception 156 indicates that the particular exception 156 actually occurred in relation to reporting a respective data interaction 108, the exception manager 140 confirms, based on additional logic and data as described below, that the potential exception 156 actually occurred. On the other hand, when a result 164 determined for a particular potential exception 156 indicates that the particular exception 156 actually did not occur in relation to reporting a respective data interaction 108, the exception manager 140 confirms, based on additional logic and data as described below, that the potential exception 156 actually did not occur. This improves accuracy of determining exceptions related to reporting data interactions 108 and allows for improved and timely detection and resolution of exceptions.

As described in more detail below, to confirm the results 164 determined for the potential exceptions 156, exception manager 140 leverages the tangle network 120. Exception manager 140 segregates the results 164 determined for the potential exceptions 156 and the related data 170 recorded by the exception manger 140 into at least three parts and stores each part in a separate data object. For example, exception manager 140 may be configured to generate at least three data objects (shown as first data object 160, second data object 166, and third data object 172). In the first data object 160, exception manager 140 stores a list of potential exceptions 156 and a corresponding result 164 determined for each of the potential exceptions 156. In the second data object 166, exception manager 140 stores pre-configured logic 168 used to determine each result 164. In an additional or alternative embodiment, exception manager 140 stores in the second data object 166 at least a portion of the related data 170 recorded for each potential exception 156. The related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156. In the third data object 172, exception manager 140 stores a list of potential exceptions 156 relating to which a decision is to be made regarding whether the results 164 determined for the potential exceptions 156 are correct. For example, for each potential exception 156 listed in the third data object 172 exception manager 140 is to determine whether a respective result 164 determined for the potential exception 156 is correct or not.

In one embodiment, exception manager 140 generates a second data file 158 and stores the first data object 160, the second data object 166 and the third data object 172 in the second data file 158.

In one embodiment, the exception manager 140 uses a machine learning (ML) model 152 to segregate the data (e.g., potential exceptions 156, results 164, related data 170 etc.) and generate the first data object 160, the second data object 166 and the third data object 172. For example, the exception manager 140 inputs the potential exceptions 156, the results 164 determined for the potential exceptions 156, and related data 170 into the ML model 152. The ML model 152 appropriately segregates the input data, generates the data objects and stores the segregated data into the data objects as described above.

Exception manager 140 may be configured to iteratively (e.g., one by one) pass to the tangle network 120, each of the first data object 160, second data object 166 and third data object 172 as new tangle nodes 132 of the tangle 130. In this context, passing a data object or data in a data object to the tangle network 120 includes generating a new tangle node 132 of the tangle 130 that stores the data object or data from the data object. For example, exception manager 140 may first pass the first data object 160 to the tangle network 120 as a first tangle node 132c of the tangle 130. After the first data object 160 has been processed by the tangle network 120, exception manager 140 may pass the second data object 166 as a second tangle node 132b of the tangle 130. After the second data object 166 has been processed by the tangle network 120, exception manager 140 may pass the third data object 172 as a third tangle node 132a of the tangle 130.

In an additional embodiment, in conjunction with passing each of the first data object 160, second data object 166 and third data object 172 to the tangle network 120, exception manager 140 may be configured to deploy a federated ML model 176 with each tangle node 132 passed to the tangle network 120. For example, in conjunction with passing the first data object 160 as the first tangle node 132c, the exception manager 140 deploys a first federated ML model 178. In conjunction with passing the second data object 166 as the second tangle node 132b, the exception manager 140 deploys a second federated ML model 182. In conjunction with passing the third data object 172 as the third tangle node 132a, the exception manager 140 deploys a third federated ML model 186. Each federated ML model 176 deployed for a particular tangle node 132 is configured to determine whether results 164 determined for one or more potential exceptions 156 are correct or not, based on data from the particular tangle node 132 and data from two previous tangle nodes 132 of the tangle 130. This is consistent with the property of a tangle network 120, wherein a computing node 104 of the tangle network 120 processing a new tangle node 132 has access to data from two previous tangle nodes 132. Thus, by leveraging the tangle network 120 to determine the correctness of the results 164, the exception manager 140 allows the determinations made by the federated ML models 176 to be based only on the latest data from the previous two tangle nodes 132 and no old historical data that may not be relevant anymore.

In certain embodiments, the exception manager 140 iteratively runs the first federated ML model 178, the second federated ML model 182, and the third federated ML model 186 one after the other to determine whether the results 164 determined for the potential exceptions 156 are correct. In an example use case, the exception manager 140 first passes to the tangle network 120 the first data object 160 as the first tangle node 132c. As described above, the first data object 160 stores a list of potential exceptions 156 and a corresponding result 164 determined for each of the potential exceptions 156. Once, the first data object 160 has been passed as the first tangle node 132c, the exception manager 140 deploys and runs the first federated ML model 178 to analyze the potential exceptions 156 and respective results 164 in the first data object 160 and determine a first confidence indicator 180 based on the analysis. The first confidence indicator 180 indicates a degree of confidence that the results 164 determined for the potential exceptions 156 are correct. For example, the exception manager 140 inputs the potential exceptions 156 and respective results 164 from the first data object 160 as input to the first federated ML model 178. Additionally, the first federated ML model 178 may receive as input, data from two previous tangle nodes 132 (e.g., tangle nodes 132d and 132e) previously added to the tangle 130. The first federated ML model 178 may be configured to determine the first confidence indicator 180 based on analyzing all input data. For example, based on analyzing the input data from the first tangle node 132c and two previous tangle nodes 132d and 132e, the first federated ML model 178 may determine a confidence indicator of 60%, which indicates a 60% confidence that the results 164 determined for the potential exceptions 156 are correct.

In one embodiment, the confidence indicator 180 determined by the first federated ML model 178 most likely has a lower value since the first data object 160 passed as the first tangle node 132c includes results 164 determined for the respective potential exceptions 156 and no other supporting/related data. Additionally, the previous two tangle nodes 132d and 132e may have data that is irrelevant to the potential exceptions 156 and/or the corresponding results 164. However, in some cases the tangle nodes 132d and 132e may have some data that is relevant to the potential exceptions 156 or the corresponding results 164 from previously monitored data interactions. In such a case, the first federated ML model 178 may determine the first confidence indicator 180 with a higher value. Generally, results generated by a machine learning model have higher accuracy when a higher amount of relevant data is provided as input to the machine learning model. For example, the tangle nodes 132d and 132e may include decisions relating to one or more similar potential exceptions 156 identified in previously monitored data interactions. For example, tangle node 132d may include decisions indicating one or more of the same results 164 were found correct corresponding to one or more same or similar exceptions as the potential exceptions 156. For example, when the first data object 160/first tangle node 132c includes a first result corresponding to a first potential exception, the tangle node 132d may include a decision indicating that the same first result was found correct for an exception similar to the first exception. This may raise the value of the first confidence indicator 180.

Once the first confidence indicator 180 has been determined, the exception manager 140 passes to the tangle network 120 the second data object 166 as the second tangle node 132b. As described above, the second data object 160 stores pre-configured logic 168 used to determine each result 164 and at least a portion of the related data 170 recorded for each potential exception 156. The related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156.

Once, the second data object 166 has been passed as the second tangle node 132b, the exception manager 140 deploys and runs the second federated ML model 182 to analyze the potential exceptions 156 and respective results 164 and determine a second confidence indicator 184 based on the analysis. Like the first confidence indicator 180, the second confidence indicator 184 indicates a degree of confidence that the results 164 determined for the potential exceptions 156 are correct. For example, the exception manager 140 inputs the potential exceptions 156 and respective results 164 from the first tangle node 132c and all the data from the second data object 166/second tangle node 132b as input to the second federated ML model 182. Additionally, the second federated ML model 178 may receive as input, data from tangle node 132d. As described above, owing to the properties of the tangle network 120, tangle node 132b has access to data from the previous two tangle nodes 132c and 132d. The second federated ML model 182 may be configured to determine the second confidence indicator 184 based on analyzing all input data. Now, since the second federated ML model 182 has the benefit of more relevant data as compared to what was available to the first federated ML model 178, the second confidence indicator 184 may have a higher value as compared to the first confidence indicator 180. For example, based on analyzing the input data from the second tangle node 132b and two previous tangle nodes 132c and 132d, the second federated ML model 182 may determine a second confidence indicator 184 of 80%, which indicates an 80% confidence that the results 164 determined for the potential exceptions 156 are correct.

Once the second confidence indicator 184 has been generated, the exception manager 140 may compare the second confidence indicator 184 with a confidence threshold 195. If the value of second confidence indicator 184 equals or exceeds the confidence threshold 195, the exception manager 140 determines that the results 164 are correct. In one embodiment, upon detecting that the second confidence indicator 184 equals or exceeds the confidence threshold 195, the exception manager 140 passes to the tangle network 120 the third data object 172 as the third tangle node 132a. As described above, the third data object 160 stores a list of potential exceptions 156 relating to which a decision is to be made regarding whether the results 164 determined for the potential exceptions 156 are correct. For example, for each potential exception 156 listed in the third data object 172 a decision is to be made whether a respective result 164 determined for the potential exception 156 is correct or not.

Once, the third data object 172 has been passed as the third tangle node 132a, the exception manager 140 deploys and runs the third federated ML model 182 to determine whether each result 164 determined for the respective potential exceptions 156 included in the third data object 172/third tangle node 132a is approved or rejected. For example, exception manager 140 inputs to the second federated ML model 182 the list of potential exceptions 156 relating to which a decision is to be made from the third data object 172/third tangle node 132a and data from the previous two tangle nodes 132b and 132c. Based on all the input data, the third federated ML model 186 determines whether each result 164 determined for respective potential exceptions 156 listed in the third data object 172 is approved or not approved.

In an additional or alternative embodiments, the exception manager 140 deploys and runs the third federated ML model 182 to analyze the input data and determine a third confidence indicator 188 based on the analysis. Like the first confidence indicator 180 and the second confidence indicator 184, the third confidence indicator 188 indicates a degree of confidence that the results 164 determined for the potential exceptions 156 listed in the third data object 172/third tangle node 132a are correct.

In additional or alternative embodiments, upon detecting that the second confidence indicator 184 determined by the second federated ML model 182 is lower than the confidence threshold 195, the exception manager 140 determines that more related data 170 is needed by the second federated ML model 182 to raise the second confidence indicator 184 above the confidence threshold 195. For example, in response to detecting that the second confidence indicator 184 is lower than the confidence threshold 195, exception manager 140 uses (e.g., runs) the ML model 152 to iteratively generate one or more additional data objects that include additional related data 170. Each additional data object is passed as an additional tangle node 132 to the tangle 130 and a separate federated ML model 176 is deployed for each of the additional tangle nodes 132 to determine an additional confidence indicator. As more related data generally raises the accuracy of results generated by a machine learning model, each additional tangle node 132 having additional related data 170 likely raises the value of the additional confidence indicators. In one embodiment, the ML model 152 iteratively generates additional data objects, adds the additional data objects to the tangle 130, and determines additional confidence indicators based on the additional data objects until an additional confidence indicator equals or exceeds the confidence threshold 195. In other words, the exception manager 140 continues to iteratively generate and pass additional tangle nodes 132 with additional related data 170 until an additional confidence indicator equals or exceeds the confidence threshold 195. The exception manager 140 passes the third data object 172 to the tangle 130 only after an additional confidence indicator equals or exceeds the confidence threshold 195.

In certain embodiments, after determining (e.g., using the third federated ML model 186) whether each result 164 determined for the respective potential exceptions 156 included in the third data object 172/third tangle node 132a is approved or rejected, exception manager 140 generates a report 189 including a list of plurality of the potential exceptions 156 that are determined as valid exceptions. For example, from the potential exceptions 156 whose results 164 were approved by the third federated ML model 186, the exception manager 140 extracts those potential exceptions 156 whose respective results 164 indicate that those potential exceptions 156 actually occurred and lists those potential exceptions 156 in the report 189.

Exception manager 140 may be configured to determine one or more remedial measures to correct the valid exceptions identified in the report 189 and run the one or more remedial measures to correct the valid exceptions. For example, when an exception indicates that a particular data interaction 108 that was to be reported was actually not reported, the exception manager 140 may re-send a corrected reporting including a reporting relating to the particular data interaction 108.

It may be noted that in an example banking use case, data interactions 108 may include trading transactions relating to shares, bonds, options etc. placed using a bank. The trading transactions may need to be reported to certain regulatory entities and exceptions may occur relating to reporting of these transactions.

FIG. 2 illustrates a flowchart of an example method 200 for detecting exceptions associated with reporting data interactions 108, in accordance with one or more embodiments of the present disclosure. Method 200 may be performed by the exception manager 140 shown in FIG. 1.

At operation 202, the exception manager 140 monitors a plurality of data interactions 108.

At operation 204, the exception manager 140 identifies a plurality of potential exceptions 156 relating to the data interactions 108, wherein each potential exception 156 relating to a particular data interaction 108 indicates a possible error associated with reporting the data interaction 108 to an entity.

As described above, exception manager 140 may be configured to monitor a plurality of data interactions 108 performed in the computing infrastructure 102. For example, a data interaction 108 performed in the computing infrastructure may include transfer of data objects between two computing nodes 104 of the computing infrastructure. Based on monitoring the plurality of data interactions 108, exception manager 140 may be configured to determine one or more potential exceptions 156 in relation to each of the monitored data interactions 108. A potential exception 156 associated with a particular data interaction 108 may include a reporting error that is known to occur and/or can occur in relation to reporting the particular data interaction 108, for example, to a designated entity. Exception manager 140 may be configured to determine a list of all potential exceptions 156 related to each monitored data interaction 108. In one embodiment, exception manager 140 generates a first data file 154 and stores the list of potential exceptions 156 determined for the monitored data interactions 108 in the first data file 154.

At operation 206, the exception manager 140 analyzes each potential exception 156 based on a respective pre-configured logic 168 to determine a result 164 relating to the potential exception 156, wherein the result 164 indicates whether the potential exception 156 is a valid exception.

As described above, exception manager 140 may be configured to analyze each potential exception 156 from the first data file 154 and determine a result 164 in relation to the potential exception 156, wherein the result 164 indicates whether the potential exception 156 is a valid exception meaning that the potential exception 156 actually occurred during reporting of the particular data interaction 108. For example, for a potential exception 156 listed in the first data file 154, a result determined by the exception manager 140 includes whether the potential exception is valid (actually occurred) or invalid (did not occur). To determine a result 164 in relation to a potential exception 156 determined for a particular data interaction 108, the exception manager 140 applies a pre-configured logic 168 that is configured to determine whether the potential exception 156 is a valid exception, meaning whether the potential exception 156 actually occurred during reporting of the particular data interaction 108. The pre-configured logic 168 may be configured to use one or more data points to determine whether a potential exception 156 actually occurred in relation to reporting a particular data interaction 108. Following the example described above, when a particular data interaction 108 is to be reported when the number of data objects transferred between computing nodes 104 as part of the particular data interaction 108 equals or exceeds a threshold, the pre-configured logic 168 may be configured to use the number of data objects scheduled to be transferred to determine whether an exception has occurred in relation to reporting the particular data interaction 108.

In additional or alternative embodiments, the exception manager 140 may be configured to record related data 170 that may be relevant to determining whether a particular potential exception 156 is a valid exception. Related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156. For example, other data points that may be relevant to the particular potential exception 156 may include performance parameters associated with a computing node 104 that is configured to process the reporting of the particular potential exception 156. As described above, in one example, a delay in processing reporting of a particular exception 156 may cause delayed reporting of a respective data interaction 108 associated with the exception 156 or to cause the data interaction to be not reported at all.

At operation 208, the exception manager 140 generates a plurality of data objects (e.g., first data object 160, second data object 166, third data object 172), wherein each data object 160, 166, 172 comprises one or more of the potential exceptions 156, results 164 determined for the potential exceptions 156, pre-configured logic 168 used to analyze the potential exceptions 156, data (e.g., related data 170) used in analyzing the potential exceptions 156 based on the respective pre-configured logic 168.

As described above, exception manager 140 may be configured to confirm a result 164 determined for a potential exception 156. In other words, the exception manager 140 may be configured to determine whether a result 164 determined for a potential exception 156 is correct or incorrect. For example, when a result 164 determined for a particular potential exception 156 indicates that the particular exception 156 actually occurred in relation to reporting a respective data interaction 108, the exception manager 140 confirms, based on additional logic and data as described below, that the potential exception 156 actually occurred. On the other hand, when a result 164 determined for a particular potential exception 156 indicates that the particular exception 156 actually did not occur in relation to reporting a respective data interaction 108, the exception manager 140 confirms, based on additional logic and data as described below, that the potential exception 156 actually did not occur. This improves accuracy of determining exceptions related to reporting data interactions 108 and allows for improved and timely detection and resolution of exceptions.

As described in more detail below, to confirm the results 164 determined for the potential exceptions 156, exception manager 140 leverages the tangle network 120. Exception manager 140 segregates the results 164 determined for the potential exceptions 156 and the related data 170 recorded by the exception manger 140 into at least three parts and stores each part in a separate data object. For example, exception manager 140 may be configured to generate at least three data objects (shown as first data object 160, second data object 166, and third data object 172). In the first data object 160, exception manager 140 stores a list of potential exceptions 156 and a corresponding result 164 determined for each of the potential exceptions 156. In the second data object 166, exception manager 140 stores pre-configured logic 168 used to determine each result 164. In an additional or alternative embodiment, exception manager 140 stores in the second data object 166 at least a portion of the related data 170 recorded for each potential exception 156. The related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156. In the third data object 172, exception manager 140 stores a list of potential exceptions 156 relating to which a decision is to be made regarding whether the results 164 determined for the potential exceptions 156 are correct. For example, for each potential exception 156 listed in the third data object 172 exception manager 140 is to determine whether a respective result 164 determined for the potential exception 156 is correct or not.

In one embodiment, exception manager 140 generates a second data file 158 and stores the first data object 160, the second data object 166 and the third data object 172 in the second data file 158.

At operation 210, the exception manager 140 passes the plurality of data objects 160, 166, 172 as nodes (e.g., tangle nodes 132) of a tangle 130 associated with a tangle network 120, wherein each data object 160, 166, 172 is passed to the tangle 130 as a separate tangle node 132.

As described above, exception manager 140 may be configured to iteratively (e.g., one by one) pass to the tangle network 120, each of the first data object 160, second data object 166 and third data object 172 as new tangle nodes 132 of the tangle 130. In this context, passing a data object or data in a data object to the tangle network 120 includes generating a new tangle node 132 of the tangle 130 that stores the data object or data from the data object. For example, exception manager 140 may first pass the first data object 160 to the tangle network 120 as a first tangle node 132c of the tangle 130. After the first data object 160 has been processed by the tangle network 120, exception manager 140 may pass the second data object 166 as a second tangle node 132b of the tangle 130. After the second data object 166 has been processed by the tangle network 120, exception manager 140 may pass the third data object 172 as a third tangle node 132a of the tangle 130.

At operation 212, the exception manager 140 deploys a federated machine learning model 176 associated with each tangle node 132 passed to the tangle 130 to determine whether the results 164 determined for the potential exceptions 156 are correct, wherein each federated machine learning model 176 associated with a particular tangle node 132 of the tangle 130 uses data from the particular tangle node 132 and previous two tangle nodes 132 of the tangle 130 to determine whether the results 164 determined for the potential exceptions 156 are correct. In an embodiment, determining whether a result 164 associated with a potential exception 156 is correct includes when the result 164 indicates that the potential exception 156 is a valid exception, determining whether the result 164 correctly identifies the potential exception 156 as a valid exception. In an additional or alternative embodiment, determining whether a result 164 associated with a potential exception 156 is correct includes when the result 164 indicates that the potential exception 156 is an invalid exception, determining whether the result 164 correctly identifies the potential exception 156 as an invalid exception.

As described above, in conjunction with passing each of the first data object 160, second data object 166 and third data object 172 to the tangle network 120, exception manager 140 may be configured to deploy a federated ML model 176 with each tangle node 132 passed to the tangle network 120. For example, in conjunction with passing the first data object 160 as the first tangle node 132c, the exception manager 140 deploys a first federated ML model 178. In conjunction with passing the second data object 166 as the second tangle node 132b, the exception manager 140 deploys a second federated ML model 182. In conjunction with passing the third data object 172 as the third tangle node 132a, the exception manager 140 deploys a third federated ML model 186. Each federated ML model 176 deployed for a particular tangle node 132 is configured to determine whether results 164 determined for one or more potential exceptions 156 are correct or not, based on data from the particular tangle node 132 and data from two previous tangle nodes 132 of the tangle 130. This is consistent with the property of a tangle network 120, wherein a computing node 104 of the tangle network 120 processing a new tangle node 132 has access to data from two previous tangle nodes 132. Thus, by leveraging the tangle network 120 to determine the correctness of the results 164, the exception manager 140 allows the determinations made by the federated ML models 176 to be based only on the latest data from the previous two tangle nodes 132 and no old historical data that may not be relevant anymore.

In certain embodiments, the exception manager 140 iteratively runs the first federated ML model 178, the second federated ML model 182, and the third federated ML model 186 one after the other to determine whether the results 164 determined for the potential exceptions 156 are correct. In an example use case, the exception manager 140 first passes to the tangle network 120 the first data object 160 as the first tangle node 132c. As described above, the first data object 160 stores a list of potential exceptions 156 and a corresponding result 164 determined for each of the potential exceptions 156. Once, the first data object 160 has been passed as the first tangle node 132c, the exception manager 140 deploys and runs the first federated ML model 178 to analyze the potential exceptions 156 and respective results 164 in the first data object 160 and determine a first confidence indicator 180 based on the analysis. The first confidence indicator 180 indicates a degree of confidence that the results 164 determined for the potential exceptions 156 are correct. For example, the exception manager 140 inputs the potential exceptions 156 and respective results 164 from the first data object 160 as input to the first federated ML model 178. Additionally, the first federated ML model 178 may receive as input, data from two previous tangle nodes 132 (e.g., tangle nodes 132d and 132e) previously added to the tangle 130. The first federated ML model 178 may be configured to determine the first confidence indicator 180 based on analyzing all input data. For example, based on analyzing the input data from the first tangle node 132c and two previous tangle nodes 132d and 132e, the first federated ML model 178 may determine a confidence indicator of 60%, which indicates a 60% confidence that the results 164 determined for the potential exceptions 156 are correct.

In one embodiment, the confidence indicator 180 determined by the first federated ML model 178 most likely has a lower value since the first data object 160 passed as the first tangle node 132c includes results 164 determined for the respective potential exceptions 156 and no other supporting/related data. Additionally, the previous two tangle nodes 132d and 132e may have data that is irrelevant to the potential exceptions 156 and/or the corresponding results 164. However, in some cases the tangle nodes 132d and 132e may have some data that is relevant to the potential exceptions 156 or the corresponding results 164 from previously monitored data interactions. In such a case, the first federated ML model 178 may determine the first confidence indicator 180 with a higher value. Generally, results generated by a machine learning model have higher accuracy when a higher amount of relevant data is provided as input to the machine learning model. For example, the tangle nodes 132d and 132e may include decisions relating to one or more similar potential exceptions 156 identified in previously monitored data interactions. For example, tangle node 132d may include decisions indicating one or more of the same results 164 were found correct corresponding to one or more same or similar exceptions as the potential exceptions 156. For example, when the first data object 160/first tangle node 132c includes a first result corresponding to a first potential exception, the tangle node 132d may include a decision indicating that the same first result was found correct for an exception similar to the first exception. This may raise the value of the first confidence indicator 180.

Once the first confidence indicator 180 has been determined, the exception manager 140 passes to the tangle network 120 the second data object 166 as the second tangle node 132b. As described above, the second data object 160 stores pre-configured logic 168 used to determine each result 164 and at least a portion of the related data 170 recorded for each potential exception 156. The related data 170 associated with a particular potential exception 156 may include, but is not limited to, other exceptions that were determined as valid and are known to cause the particular potential exception 156 or result from the particular potential exception 156, data points used by the pre-configured logic 168 to determine whether the particular potential exception 156 is valid, and other data points that may be relevant to (e.g., cause) the particular potential exception 156.

Once, the second data object 166 has been passed as the second tangle node 132b, the exception manager 140 deploys and runs the second federated ML model 182 to analyze the potential exceptions 156 and respective results 164 and determine a second confidence indicator 184 based on the analysis. Like the first confidence indicator 180, the second confidence indicator 184 indicates a degree of confidence that the results 164 determined for the potential exceptions 156 are correct. For example, the exception manager 140 inputs the potential exceptions 156 and respective results 164 from the first tangle node 132c and all the data from the second data object 166/second tangle node 132b as input to the second federated ML model 182. Additionally, the second federated ML model 178 may receive as input, data from tangle node 132d. As described above, owing to the properties of the tangle network 120, tangle node 132b has access to data from the previous two tangle nodes 132c and 132d. The second federated ML model 182 may be configured to determine the second confidence indicator 184 based on analyzing all input data. Now, since the second federated ML model 182 has the benefit of more relevant data as compared to what was available to the first federated ML model 178, the second confidence indicator 184 may have a higher value as compared to the first confidence indicator 180. For example, based on analyzing the input data from the second tangle node 132b and two previous tangle nodes 132c and 132d, the second federated ML model 182 may determine a second confidence indicator 184 of 80%, which indicates an 80% confidence that the results 164 determined for the potential exceptions 156 are correct.

Once the second confidence indicator 184 has been generated, the exception manager 140 may compare the second confidence indicator 184 with a confidence threshold 195. If the value of second confidence indicator 184 equals or exceeds the confidence threshold 195, the exception manager 140 determines that the results 164 are correct. In one embodiment, upon detecting that the second confidence indicator 184 equals or exceeds the confidence threshold 195, the exception manager 140 passes to the tangle network 120 the third data object 172 as the third tangle node 132a. As described above, the third data object 160 stores a list of potential exceptions 156 relating to which a decision is to be made regarding whether the results 164 determined for the potential exceptions 156 are correct. For example, for each potential exception 156 listed in the third data object 172 a decision is to be made whether a respective result 164 determined for the potential exception 156 is correct or not.

Once, the third data object 172 has been passed as the third tangle node 132a, the exception manager 140 deploys and runs the third federated ML model 182 to determine whether each result 164 determined for the respective potential exceptions 156 included in the third data object 172/third tangle node 132a is approved or rejected. For example, exception manager 140 inputs to the second federated ML model 182 the list of potential exceptions 156 relating to which a decision is to be made from the third data object 172/third tangle node 132a and data from the previous two tangle nodes 132b and 132c. Based on all the input data, the third federated ML model 186 determines whether each result 164 determined for respective potential exceptions 156 listed in the third data object 172 is approved or not approved.

In an additional or alternative embodiments, the exception manager 140 deploys and runs the third federated ML model 182 to analyze the input data and determine a third confidence indicator 188 based on the analysis. Like the first confidence indicator 180 and the second confidence indicator 184, the third confidence indicator 188 indicates a degree of confidence that the results 164 determined for the potential exceptions 156 listed in the third data object 172/third tangle node 132a are correct. At operation 214, the exception manager 140 checks whether a confidence indicator (e.g., confidence indicator 184 and/or confidence indicator 188) equals or exceeds a confidence threshold 195. If the confidence indicator (e.g., confidence indicator 184 and/or confidence indicator 188) is lower than the confidence threshold 195, method 200 proceeds to operation 216, where the exception manager 140 generates and passes an additional data object as an additional new tangle node 132 to the tangle 130. At operation 218, the exception manager 140 deploys an additional federated ML model 176 to calculate an additional confidence indicator based on the additional data object/new tangle node and the previous two tangle nodes 132.

As described above, in additional or alternative embodiments, upon detecting that the second confidence indicator 184 determined by the second federated ML model 182 is lower than the confidence threshold 195, the exception manager 140 determines that more related data 170 is needed by the second federated ML model 182 to raise the second confidence indicator 184 above the confidence threshold 195. For example, in response to detecting that the second confidence indicator 184 is lower than the confidence threshold 195, exception manager 140 uses (e.g., runs) the ML model 152 to iteratively generate one or more additional data objects that include additional related data 170. Each additional data object is passed as an additional tangle node 132 to the tangle 130 and a separate federated ML model 176 is deployed for each of the additional tangle nodes 132 to determine an additional confidence indicator. As more related data generally raises the accuracy of results generated by a machine learning model, each additional tangle node 132 having additional related data 170 likely raises the value of the additional confidence indicators. In one embodiment, the ML model 152 iteratively generates additional data objects, adds the additional data objects to the tangle 130, and determines additional confidence indicators based on the additional data objects until an additional confidence indicator equals or exceeds the confidence threshold 195. In other words, the exception manager 140 continues to iteratively generate and pass additional tangle nodes 132 with additional related data 170 until an additional confidence indicator equals or exceeds the confidence threshold 195. The exception manager 140 passes the third data object 172 to the tangle 130 only after an additional confidence indicator equals or exceeds the confidence threshold 195.

When the confidence indicator (e.g., confidence indicator 184, confidence indicator 188 and/or additional confidence indicator) equals or exceeds the confidence threshold, method 200 proceeds to operation 220.

At operation 220, the exception manager 140 generates a report comprising a plurality of the potential exceptions 156 determined as valid.

In certain embodiments, after determining (e.g., using the third federated ML model 186) whether each result 164 determined for the respective potential exceptions 156 included in the third data object 172/third tangle node 132a is approved or rejected, exception manager 140 generates a report 189 including a list of plurality of the potential exceptions 156 that are determined as valid exceptions. For example, from the potential exceptions 156 whose results 164 were approved by the third federated ML model 186, the exception manager 140 extracts those potential exceptions 156 whose respective results 164 indicate that those potential exceptions 156 actually occurred and lists those potential exceptions 156 in the report 189.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a tangle network comprising a plurality of computing nodes connected to a network, wherein the tangle network stores a tangle comprising a directed acyclic graph (DAG) of a plurality of nodes; and
at least one processor communicatively coupled to the tangle network and configured to:
monitor a plurality of data interactions;
identify a plurality of potential exceptions relating to the data interactions, wherein each potential exception relating to a particular data interaction indicates a possible error associated with reporting the data interaction to an entity;
analyze each potential exception based on a respective pre-configured logic to determine a result relating to the potential exception, wherein the result indicates whether the potential exception is a valid exception;
generate a plurality of data objects, wherein each data object comprises one or more of the potential exceptions, results determined for the potential exceptions, pre-configured logic used to analyze the potential exceptions, or data used in analyzing the potential exceptions based on the respective pre-configured logic;
pass the plurality of data objects as nodes of the tangle associated with the tangle network, wherein each data object is passed to the tangle as a separate node;
deploy a federated machine learning model associated with each node passed to the tangle to determine whether the results determined for the potential exceptions are correct, wherein each federated machine learning model associated with a particular node of the tangle uses data from the particular node and previous two nodes of the tangle to determine whether the results determined for the potential exceptions are correct, wherein determining whether a result associated with a potential exception is correct comprises:
when the result indicates that the potential exception is a valid exception, determining whether the result correctly identifies the potential exception as a valid exception; and
when the result indicates that the potential exception is an invalid exception, determining whether the result correctly identifies the potential exception as an invalid exception; and
generate a report comprising a plurality of the potential exceptions determined as valid.

2. The system of claim 1, wherein the at least one processor is configured to generate the plurality of data objects by:
generating a first data object comprising a list of the potential exceptions and an indication of whether each exception in the list was determined to be valid;
generating a second data object comprising the pre-configured logic and data used to determine whether each potential exception is valid; and
generating a third data object comprising a list of potential exceptions relating to which a decision is to be made regarding whether the results determined for the potential exceptions are correct, wherein the decision relating to each potential exception indicates whether a respective result determined for the potential exception is correct.

3. The system of claim 2, wherein the at least one processor is configured to pass the plurality of data objects to the tangle by:
passing the first data object to the tangle as a first node of the tangle;
after passing the first data object to the tangle, passing the second data object to the tangle as a second node of the tangle; and
after passing the second data object to the tangle, passing the third data object to the tangle as a third node of the tangle.

4. The system of claim 3, wherein the at least one processor is further configured to:
deploy a first federated machine learning model that is configured to receive first input data from the first node and at least two previous nodes of the tangle;
deploy a second federated machine learning model that is configured to receive second input data from the second node, the first node and a node previous to the first node of the tangle; and
deploy a third federated machine learning model that is configured to receive third input data from the third node, the second node and the first node.

5. The system of claim 4, wherein the at least one processor is further configured to:
iteratively run the first federated machine learning model, the second machine learning model and the third machine learning model one after the other to determine whether the results determined for the potential exceptions are correct.

6. The system of claim 5, wherein the at least one processor is configured to determine whether the results determined for the potential exceptions are correct by:
running the first federated machine learning model that determines a first confidence indicator based on the first input data from the first node and at least two previous nodes of the tangle, where in the first confidence indicator indicates a degree of confidence that the results determined for the potential exceptions are correct;
running the second federated machine learning model that determines a second confidence indicator based on the second input data from the second node, the first node and a node previous to the first node of the tangle, wherein the second confidence indicator is higher than the first confidence indicator and indicates with a higher degree of confidence that the results determined for the potential exceptions are correct; and
in response to determining that the second confidence indicator equals or exceeds a threshold:
determining that the results determined for the potential exceptions are correct; and
running the third federated machine learning model that determines, for each potential exception in the list of potential exceptions in the third data object, whether the respective result determined for the potential exception is approved or rejected.

7. The system of claim 6, wherein the at least one processor is further configured to:
run the third federated machine learning model to determine a third confidence indicator based on the third input data from the third node, the second node and the first node.

8. The system of claim 1, wherein the at least one processor is further configured to:
determine one or more remedial measures to correct valid exceptions; and
run the one or more remedial measures to correct the valid exceptions.

9. A method for detecting exceptions associating with data interactions, comprising:
monitoring a plurality of data interactions;
identifying a plurality of potential exceptions relating to the data interactions, wherein each potential exception relating to a particular data interaction indicates a possible error associated with reporting the data interaction to an entity;
analyzing each potential exception based on a respective pre-configured logic to determine a result relating to the potential exception, wherein the result indicates whether the potential exception is a valid exception;
generating a plurality of data objects, wherein each data object comprises one or more of the potential exceptions, results determined for the potential exceptions, pre-configured logic used to analyze the potential exceptions, or data used in analyzing the potential exceptions based on the respective pre-configured logic;
passing the plurality of data objects as nodes of a tangle associated with a tangle network, wherein each data object is passed to the tangle as a separate node, wherein the tangle network comprises a plurality of computing nodes connected to a network, wherein the tangle network stores the tangle comprising a directed acyclic graph (DAG) of a plurality of nodes;
deploying a federated machine learning model associated with each node passed to the tangle to determine whether the results determined for the potential exceptions are correct, wherein each federated machine learning model associated with a particular node of the tangle uses data from the particular node and previous two nodes of the tangle to determine whether the results determined for the potential exceptions are correct, wherein determining whether a result associated with a potential exception is correct comprises:
when the result indicates that the potential exception is a valid exception, determining whether the result correctly identifies the potential exception as a valid exception; and
when the result indicates that the potential exception is an invalid exception, determining whether the result correctly identifies the potential exception as an invalid exception; and
generating a report comprising a plurality of the potential exceptions determined as valid.

10. The method of claim 9, wherein generating the plurality of data objects comprises:
generating a first data object comprising a list of the potential exceptions and an indication of whether each exception in the list was determined to be valid;
generating a second data object comprising the pre-configured logic and data used to determine whether each potential exception is valid; and
generating a third data object comprising a list of potential exceptions relating to which a decision is to be made regarding whether the results determined for the potential exceptions are correct, wherein the decision relating to each potential exception indicates whether a respective result determined for the potential exception is correct.

11. The method of claim 10, wherein passing the plurality of data objects to the tangle comprises:
passing the first data object to the tangle as a first node of the tangle;
after passing the first data object to the tangle, passing the second data object to the tangle as a second node of the tangle; and
after passing the second data object to the tangle, passing the third data object to the tangle as a third node of the tangle.

12. The method of claim 11, further comprising:
deploying a first federated machine learning model that is configured to receive first input data from the first node and at least two previous nodes of the tangle;
deploying a second federated machine learning model that is configured to receive second input data from the second node, the first node and a node previous to the first node of the tangle; and
deploying a third federated machine learning model that is configured to receive third input data from the third node, the second node and the first node.

13. The method of claim 12, further comprising:
iteratively running the first federated machine learning model, the second machine learning model and the third machine learning model one after the other to determine whether the results determined for the potential exceptions are correct.

14. The method of claim 13, wherein determining whether the results determined for the potential exceptions are correct comprises:
running the first federated machine learning model that determines a first confidence indicator based on the first input data from the first node and at least two previous nodes of the tangle, where in the first confidence indicator indicates a degree of confidence that the results determined for the potential exceptions are correct;
running the second federated machine learning model that determines a second confidence indicator based on the second input data from the second node, the first node and a node previous to the first node of the tangle, wherein the second confidence indicator is higher than the first confidence indicator and indicates with a higher degree of confidence that the results determined for the potential exceptions are correct; and
in response to determining that the second confidence indicator equals or exceeds a threshold:
determining that the results determined for the potential exceptions are correct; and
running the third federated machine learning model that determines, for each potential exception in the list of potential exceptions in the third data object, whether the respective result determined for the potential exception is approved or rejected.

15. The method of claim 14, further comprising:
run the third federated machine learning model to determine a third confidence indicator based on the third input data from the third node, the second node and the first node.

16. A non-transitory computer-readable medium storing instructions that when executed by a processor cause the processor to:
monitor a plurality of data interactions;
identify a plurality of potential exceptions relating to the data interactions, wherein each potential exception relating to a particular data interaction indicates a possible error associated with reporting the data interaction to an entity;
analyze each potential exception based on a respective pre-configured logic to determine a result relating to the potential exception, wherein the result indicates whether the potential exception is a valid exception;
generate a plurality of data objects, wherein each data object comprises one or more of the potential exceptions, results determined for the potential exceptions, pre-configured logic used to analyze the potential exceptions, or data used in analyzing the potential exceptions based on the respective pre-configured logic;
pass the plurality of data objects as nodes of a tangle associated with a tangle network, wherein each data object is passed to the tangle as a separate node, wherein the tangle network comprises a plurality of computing nodes connected to a network, wherein the tangle network stores the tangle comprising a directed acyclic graph (DAG) of a plurality of nodes;
deploy a federated machine learning model associated with each node passed to the tangle to determine whether the results determined for the potential exceptions are correct, wherein each federated machine learning model associated with a particular node of the tangle uses data from the particular node and previous two nodes of the tangle to determine whether the results determined for the potential exceptions are correct, wherein determining whether a result associated with a potential exception is correct comprises:
when the result indicates that the potential exception is a valid exception, determining whether the result correctly identifies the potential exception as a valid exception; and
when the result indicates that the potential exception is an invalid exception, determining whether the result correctly identifies the potential exception as an invalid exception; and
generate a report comprising a plurality of the potential exceptions determined as valid.

17. The non-transitory computer-readable medium of claim 16, wherein generating the plurality of data objects comprises:
generating a first data object comprising a list of the potential exceptions and an indication of whether each exception in the list was determined to be valid;
generating a second data object comprising the pre-configured logic and data used to determine whether each potential exception is valid; and
generating a third data object comprising a list of potential exceptions relating to which a decision is to be made regarding whether the results determined for the potential exceptions are correct, wherein the decision relating to each potential exception indicates whether a respective result determined for the potential exception is correct.

18. The non-transitory computer-readable medium of claim 17, wherein passing the plurality of data objects to the tangle comprises:
passing the first data object to the tangle as a first node of the tangle;
after passing the first data object to the tangle, passing the second data object to the tangle as a second node of the tangle; and
after passing the second data object to the tangle, passing the third data object to the tangle as a third node of the tangle.

19. The non-transitory computer-readable medium of claim 18, wherein the instructions further cause the processor to:
deploy a first federated machine learning model that is configured to receive first input data from the first node and at least two previous nodes of the tangle;
deploy a second federated machine learning model that is configured to receive second input data from the second node, the first node and a node previous to the first node of the tangle; and
deploy a third federated machine learning model that is configured to receive third input data from the third node, the second node and the first node.

20. The non-transitory computer-readable medium of claim 19, wherein the instructions further cause the processor to:
iteratively run the first federated machine learning model, the second machine learning model and the third machine learning model one after the other to determine whether the results determined for the potential exceptions are correct.
